(19) United States
(12) Patent Application Publication
(10) Pub. No.: US 2009/0171790 A1
(43) Pub. Date: Jul. 2, 2009

(54) Time based targeted advertising

(75) Inventor: Nagendra Nagarajayya, Pleasanton, CA (US)

Correspondence Address: transaxtions llc;Nagendra Nagarajayya, 4302 Denker Dr, Pleasanton, CA, 94588, US

(73) Assignee: TRANSAXTIONS LLC, Pleasanton, CA (US)

(21) Appl. No.: 12/344,747

(22) Filed: Dec. 29, 2008

Related U.S. Application Data
(63) Continuation of application No. 61/018,486, filed on Jan. 1, 2008.

(51) Int. Cl. G06Q 30/00; G06F 15/16; G06F 17/30

(52) U.S. Cl. 705/14; 709/203; 705/30; 705/37; 707/3; 707/E17.014

(57) ABSTRACT

A system and method to display advertising using a client and a server device enabling streaming advertisements onto the client device using a timing mechanism. Said timing mechanism allows selected target areas on the client display to be updated at regular intervals to create a visual perception of motion.

### FIELD OF THE INVENTION

The present invention relates to displaying advertising on a client device with a timing mechanism. The timing mechanism enables dynamic content to be streamed from a server device to the client device.

### BACKGROUND OF THE INVENTION

Advertising is a communication medium allowing a product or a service to be sold. Advertising enables creation of brand loyalty and increasing brand awareness. Advertising media can be television, newspapers, internet, radio, cinema, magazines, billboards, etc. Advertising can be traced to early periods, as early as the Egyptians advertising on papyrus. Early advertising was more pictorial then text as the general populace could not read and write, but the printing press changed advertising, people became more knowledgeable and could read and write. Advertisements became part of newspapers, magazines, radio, televisions, [etc.]. and with the introduction of computer systems and the development of the internet became a part of it. Internet companies now rely solely on this medium as their revenue model. Advertising on the internet or on a network is text and graphics with sound. Text advertising is usually some text followed by a link so that when a user clicks on the link the user is transferred to the advertiser site. Text enables relevant advertising to be shown to the context of a page or a search. Images are usually shown as banners and are used to increase brand awareness. Text associated with images is used to increase the relevancy of the banners or images shown. The text in the above said advertising is usually static while images can be grouped together to create exciting dynamic content.

The advertisement and content on the internet is usually viewed through a browser application. The text and images are formatted as HTML. HTML is a tag language and is generally used to describe the content. HTML can also be associated with JavaScript. JavaScript allows dynamic actions to be associated with the tag language and can also be used to provide a rich experience. Advertising, similar to what is seen on televisions can be enabled through dedicated clients that stream in media with sound. These dedicated clients are usually installed on the browser application as plugins.

This invention describes a new way to create the perception of motion with text and images. The invention does not need any specialized client plugins to create or view this motion, increasing the ease, delivery and reach of the medium to increase brand awareness, loyalty and sales.

### BRIEF DESCRIPTION OF THE INVENTION

Advertising on the net is very dynamic from videos to banner images to text based ads. Videos can be streamed from servers on the server side allowing full motion to be shown on the client but this needs a specialized client. GIF images allow motion to be shown through multiple images within a single image. Banner images use these GIF images to show some exciting content. This invention describes using a client device and a server device to create streaming ads on the client device using a timing mechanism. Said timing mechanism allows selected target areas on the client display to be updated at regular intervals to create a visual perception of motion.

### BRIEF DESCRIPTION OF THE DRAWINGS

The accompanying drawings, which are incorporated into and constitute a part of this specification, illustrate one or more embodiments of the present invention and, together with detailed description, serve to explain the principles and implementations of the invention.

FIG. 1 is an illustration of the advertisement system.

FIG. 2 is a flow chart illustrating the flow of information between the client and server device.

FIG. 3 is a flow chart illustrating the flow of information between the server device and the advertisement server on a request from a client device.

FIG. 4 is an illustration of an advertisement object.

FIG. 5 is a flow chart of a customer creating an advertisement.

FIG. 6 is a flow chart of a publisher injecting an advertisement into publisher content.

FIG. 7 is a flow chart illustrating a click on an advertisement.

### REFERENCES CITED

U.S. PATENT DOCUMENTS

| | | | |
|---|---|---|---|
| 20080313043 | Dec. 18, 2008 | Axler; Noah; et al | 705/14 |
| 20080313307 | Dec. 18, 2008 | Celik; Tantek; | 709/18 |

### OTHER REFERENCES

### Parents Case Text

### CROSS-REFERENCE TO RELATED APPLICATIONS

This application claims benefit of US provisional patent application No. 61018486, titled “Time based targeted advertising” filed Jan. 1, 2008 by the present inventor.

### DETAILED DESCRIPTION OF PREFERRED EMBODIMENTS

Embodiments of the present invention are described herein in the context of a method and system for emulating a competitive process. Those of ordinary skill in the art will realize that the following detailed description of the present invention is illustrative only and is not intended to be in any way limiting. Other embodiments of the present invention will readily suggest themselves to such skilled persons having the benefit of the disclosure. Reference will now be made in detail to the implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application—and business related constraints, and that these specific goals will vary from one implementation to another and from one developer to another. Moreover, it will be appreciated that such a development effort might be complex and time consuming, but would nevertheless be routine undertaking of engineering for those of ordinary skill in the art having the benefit of this disclosure.

In accordance with the present invention, the components, process steps, and/or data structures may be implemented using various types of operating systems, computing platforms, computer programs, and or/general purpose machines. In addition, those of ordinary skill in the art will recognize that devices of a less general purpose nature such as hardwired devices, field programmable gate arrays (FPGAs), application specific integrated circuits (ASICs), or the like, may also be used without departing from the scope and spirit of the inventive concepts disclosed herein.

A number of terms are used herein to describe features of embodiments of the present invention.

As used herein, the term “advertisement” will be used to refer to any of a number of formats (known and to be developed) for showing content to a operator or user or viewers or customer, [etc.] As used herein, the term “advertisement” may be used to refer to the content shown on a client device display. The content might include text, graphics and sound. The text might contain a title, description, a visual link and an actual link to transfer control on a click.

As used herein, the phrase “computer system” is usually made up of a processor, memory, storage, network, clock, input devices and output devices. Input devices can be a keyboard, a pointer device such as a mouse, touch screen, [etc.]. Output devices usually are display, printers, plotters, and controllers, [etc.]. The brain of a computer system is usually the processor such as a microprocessor. A microprocessor executes machine level instructions that enable it to perform logic as well as communicate with the input and output devices. The machine level instructions can be executed with dedicated electronic circuits or use a higher level programmable code that enables the microprocessor to execute a task. The computer system usually at startup, loads an operating system (OS) that manages the input and output devices and also enables executing higher level applications. A server device is a computer based system that usually responds to a client device request. The server device executes a server application that can listen to client requests and respond back with a response. A client device is again a computer based system that communicates across a network 140 with a server device for content. The client device can be a thin client or a thick client. In a thin client, the client device does not handle much processing other than collect input send it across to the server for processing and output the response from the server onto the output devices on the client, like a display, [etc.]. In a thick client, the client device might run an operating system itself, do more processing and communicate with the server device as needed. The communication is usually handled by higher level applications being executed on the client device which make use of networking means to communicate.

As used herein, the phrase “client device” 120 will be used to refer to the device used by a user to view the advertisement. The phrase “client device” has also been used broadly to refer to client applications executing on the device. The client device can be a general purpose computer system with a processor, storage, network connectivity and a display. The client device usually executes a client application such as a browser that can communicate across a network with a server device and retrieve content. The retrieved content is shown on the client display. The browser can also execute program code such as JavaScript, [etc.]. The browser makes use of the clock signals generated on the client device to enable timer services allowing program code to be executed at regular intervals.

As used herein, the phrase “server device” 150 may be used to refer to a device that executes a server application waiting to respond to a client request. The phrase “server device” has been broadly used to refer to server applications executing on the server device. On a client request such as a request from a browser, the server application sends back content that can be shown on the browser. The content can be text, graphics, sound, etc. A server device might execute a plurality of server applications, and in an embodiment a server application might itself act as a client and make requests to other server applications executing on the server device or other server devices on the network. A server device usually handles concurrent requests from a plurality of client devices. In an embodiment a plurality of server devices may appear as one to a plurality of client devices to handle the incoming client requests and to scale in performance.

As used herein, the term “browser” 130 may be used to refer to a client application that usually executes on a client device. A web browser is usually referred to as a browser application that is used to browse content on the internet/intranet from a server device. The content usually is HTML. The browser usually has the capability to show other content. HTML is a tag based language and uses tags to identify content. An HTML document is organized into sections with a “<begin> and “<end>” tag. It begins with a <HTML> tag followed by a <HEAD> tag (section), followed by a <BODY> tag (section). A body tag acts as a container for other tags like <TABLE>, <DIV>, <SPAN>, <P>, <FONT>, [etc.]. The browser renders HTML content onto the display device making use of any Cascading Style Sheets (CSS) usually in the HEAD section to format and style the content rendered. HTML enables a viewer to enjoy print quality visuals on the display. HTML can be associated with JavaScript program code to create rich action oriented applications. A browser is also usually a JavaScript interpreter or provides such a functionality to execute JavaScript program code associated with HTML. A browser also makes use of the timer functionality on a client device enabling JavaScript program code to be executed at timer intervals. Program code sign up for these timer services using convenience function calls, such as settimer(function, delay), setinterval(function,delay) and clearinterval(id).

As used herein, the term “display” may be used to refer to the display device connected to the client device that allows content to be shown. Display is a piece of electrical equipment usually connected to the video source of the client device. The display can show text, graphics, generate sound, [etc.] . Display devices usually are (Liquid Crystal Display) LCD based but can be (Cathode Ray Tube) CRT, Plasma or Light Emitting Diode based, [etc.]. Display devices can be part of the client device as in a laptop or separated from the client device as in a general purpose computer.

As used herein, the phrase “clock signal” may be used to refer to a timing means that generates a clock signal periodically on the client device. The client device usually offers a low level Application Programmable Interface (API) enabling an operating systems or client device applications to make use of these signals to offer timer services, scheduling, [etc.] Timer services enable program code like shell scripts, application binary code, or at a higher level, an application like a browser with a program code interpreter to offer operating system type of timer services.

As used herein, the phrase “target area” will be used to refer to an area on the display device that can be used to show content. Content can be text, graphics and sound. The target area can be a simple <DIV> tag container in an embodiment. A <DIV> tag is part of the HTML tag language. A <DIV> tag container can be very powerful especially with CSS and offers almost the capability of the <BODY> tag. The <DIV> tag is rendered by the browser on to the display device as part of the HTML page being shown on the display device. A <DIV> tag has the following attributes an id, width, height, title, style. The id attribute can be used to target a <DIV> container so that content can be rendered with JavaScript program code without affecting content on other parts of the display device. To render content in an embodiment, the <DIV>tag id is looked up using a convenience method such as getElementByid, and an attribute such as innerHTML to render. Other ways of doing this would be to inject HTML language tags into the Document Object Model (DOM) of the browser application, thereby rendering content onto the display on a refresh.

As used herein, the phrase “program code” will be used to refer to code executed in a computer based system. Program code can be in interpreted form or compiled form. In interpreted form the code is at a high level in the form of a programming language and is interpreted one line at a time to execute the code. In compiled form, the program code is analyzed and compiled into a binary form that the computer system can understand and execute as instructions. The operating system of the computer system is usually in compiled form and enables executing applications, tasks, communicate across a network, with input and output devices, [etc.]. Applications can also interpret program code or compile such code to offer more services. A browser is one such application that allows content to be retrieved from a server device. The content is usually HTML. The browser usually executes a JavaScript interpreter so HTML which is a tag language can be associated with dynamic actions. JavaScript is an object oriented language, allowing HTML to be rendered, managed and manipulated on the display device. JavaScript also enables input, output and communication with a server device. A <script> tag usually identifies program code to be executed. The src attribute of the <script> tag is a link and can point to a file containing program code to be executed. The browser while parsing HTML content on recognizing a <script> tag loads the program code from the server device and executes the code using the JavaScript interpreter. The code on execution can create new HTML tags, JavaScript objects, render content, sign up with the timer service, [etc.].

As used herein, the phrase “data object” refers to an object with attributes and methods. Attribute is a specification that defines a property and is usually in the form of a name and value pair. Attributes usually have a type and rules for using the type. A type might be integer, long, character or String, Object, [etc.]. An object of a type integer may allow numbers from 0 to 2³¹−1 to be stored and operated upon. An integer object might be unsigned or signed allowing negative numbers. A character object might store values between 0 and 2¹⁶−1. A String object might be made up of multiple character objects in sequence. An object method is like a function call but with a namespace and visibility of just the object. Object methods enable manipulating the attributes of the object, like setting or retrieving the attribute value, [etc.] Objects can be extended or aggregated to form higher level types allowing complex structures to be represented and operated upon as objects. An Address object might have attributes, street, description, city, zipcode, state, and country where street might be a String object, description again might be a String object, city might be a String object, zipcode might be a Zipcode object., state might be State object and country might be a Country object. An Address object is an aggregation of multiple objects, while a Zipcode might be an extension of the String object with addition of another String object. The first String object in a Zipcode maybe named zip, while the second String object maybe named geography. The two attributes allow a Zipcode of the form postcode-geography. Methods of the form get Zipo, and storeZipo enables retrieving and storing zipcodes.

As used herein, the phrase “click” refers to a click or change in state of an input device such as a mouse or a joystick button in a computer based system.

As used herein, the phrase “link” refers to an URL. URLs are Uniform Resource Locators and are of the form http://login:password@address/context?querystring. Address can be a numeric such as an IP address or a hostname.domainname.com. query string can be of the form “parameter=value”.

As used herein, the phrase “customer” refers to a customer who creates advertisements on the server device using a client device. The customer pays for the advertisements shown on the client device. The billing might be monthly, post-paid, [etc.]

As used herein, the phrase “fixed price” refers to a type of advertisement pricing wherein the price of an advertisement to be shown is fixed. The fixed price can be configured on the server device and can be specific to a target area where the advertisement is to be shown. The fixed price can change with demand. A fixed price type has priority over a bid price type. The priority enables a fixed price advertisement to be shown even if there is a bid price advertisement available and has a higher price. The fixed price guarantees to the customer that it will be shown on the target area.

As used herein, the phrase “bid price” refers to a type of advertisement price wherein the customer bids with other customers on the price to show an advertisement. The bidding is of a forward auction type.

As used herein, the phrase “cost-sale” refers to a type of advertisement price wherein the customer does not pay to show an advertisement but pays a commission on the sale of an item resulting from showing the advertisement. The user is transferred to the customer site on a click on a link in the advertisement.

As used herein, the terms “impressions, per-click, click-sale” refers to the type of billing for an advertisement. An impression is an impression of an advertisement on a client device. Impressions allow billing a customer for showing the advertisement on a client device. The billing could be per impression or one thousand impressions also known as Cost per mil (CPM), [etc.]. Per-click is a click on the target area where an advertisement is being shown or a click on a link in the advertisement. The click is tracked and allows the customer to be billed. Click-sale is a click followed by a sale of a product being advertised or a product from the customer site. The customer is not billed for the click, but pays a commission as part of the sale.

As used herein, the phrase “query-terms” refers to parameters passed from the client device to the server device as part of a request for an advertisement. Query terms can be keywords or terms of a search such as city, state, country, adults, children, product, hotel, airfare, vacation, cruise, [etc.] The query term enables the server device to match the query-term to an attribute target terms, [etc.] in the data objects on the server device and select matching data objects to send back to the client device.

As used herein, the phrase “target-terms” refers to an attribute in the data object allowing the query-terms parameter sent by the client-device to be matched. The server device on receiving a request, uses an index to find matching advertisement object keys. In an embodiment the index might be constructed by feeding the advertisement objects to an index writer. The index writer breaks down the object attributes such as name, description, target terms into words and adds them to index. The index might be of type inverted index. To match using the index, the server device might use an index searcher that goes through the said index and finds all the documents with words that match the said terms. The matching documents could then be used to retrieve keys to the advertisement objects. The matching objects are then returned by the server and can be included in a response.

As used herein, the phrase “trapping a click in the target area” refers to capturing a click in a target area or on a link being shown in the target area. A click can be easily captured in the target area through a JavaScript function attached to the <DIV> tag through the onclick attribute. Similarly, a click on a link can be captured through a JavaScript function attached to anchor tag (<A>) onclick attribute.

As used herein, the terms “tracking a click”, “count”, “client attributes” refer to a click on an advertisement and communicating the said click to the server device. In an embodiment, it can be done by creating an image tag dynamically with the src attribute taking as parameters click id, advertisement id, target area, [etc.]. The client device sends across the image request back to the server device. The server device logs will reflect the value of the src attribute which can be processed later for billing the customer. Similarly the count value can be transferred back to the server device for billing. Every request usually will have the client attributes, ip address and session id. Additional parameters like affiliate id can also be passed so that affiliate performance can be tracked to enable paying a commission to an affiliate. In other embodiments, a click can be sent across to a server device using an XMLHttpRequest.

As used herein, the terms “sale price”, “discount percentage”, “compare link”, “compare identifier” refer to a data object with these attributes 423. The data object with these said attributes are created by a customer on the server device or sent as part of a data feed to the server device. The sale price, discount percentage and a compare link are displayed on the display device along with other attributes. A user click on the compare link is captured and a request is made to the server device address in the compare link along with at least the compare identifier as a parameter. In an embodiment, the server device address can be different from the server device that sent in the initial advertisement data object. The compare identifier enables the server device to send comparison shopping content. Comparison shopping content can be product items with the matching product codes but from different customers with different prices. The comparison shopping content is displayed on the client display. Each product shown on the display could have customer links. A click on these links usually enables the client device to retrieve content from the customer server device allowing a user of the client device to complete a sale.

As used herein, the terms “title”, “description”, “show link”, “click link” are attributes of a data object 420 shown as an advertisement on the client display device. The title might be shown in a different color compared to the description and the show link attribute, and might be rendered as a link. The “show link” value is usually the shortened meaningful address of the customer server device, while the click link attribute contains the link address of the customer server device to retrieve content from, on a click.

As used herein, the terms “count”, “count threshold” are attributes of a data object 420 and enable the program code to show a data object on the client display for that many count clock signals. Once the count threshold is crossed, the program code changes the current object to the next object to be shown. A data object usually is a cyclical link list of objects.

As used herein, the terms “Ajax”, “XmlHttpRequest” refers to the ability of the client application like a browser executing on a client device to communicate with the server device to retrieve content asynchronously. The XmlHttpRequest can be initiated on a clock signal or a count threshold trigger or a click to retrieve content from the server device; said content can be selectively refreshed onto the display device using a tag like <DIV>. Before the availability of XmlHttpRequest, a request by a browser would stop and pause functions until the request was completed. The returned content was updated as a complete HTML page and caused a flicker as well as long waits. XmlHttpRequest and selective refresh of the client display enables rich application experience with just HTML and JavaScript.

As used herein, the terms “xsocket-http”, “reverse Ajax”, “Server push” refers to the ability of the server device to push content asynchronously to a client device. The server device starts the content push based on an initial request for content from the client device and pushes the content on changes or events on the server devices or client devices. Such events on the server side might be timing means like clock signal timers, or a change of state communication from a client device such as a click or input means. Server push eliminates the need for polling the server device for content by the client device using a clock signal. Polling can be expensive in terms of resources used, while asynchronous server push eliminates the cost of these expensive resources.

As used herein, the phrase “website” refers to a server device and a web server application 160 on the server device that is able to respond back with content, usually HTML based, but could offer other services like email, cloud computing, ftp, [etc.]. A website usually has a name or an IP address. If it has a name it is registered with a name registry so that it can be discovered by users on the internet. The name is usually of the form http/www.name.XXX., where XXX is a Top Level Domain Name (TLD).

As used herein, the phrase “Object converter” refers to a object converter that allows objects with attributes to be represented as Extended Markup Language (XML) or in JavaScript Object Notation (JSON). XML is a tag language that can be used to describe objects with attributes, schemas, [etc.]. HTML tag language is nothing else but XML and is used to describe content to be shown on a display device. XML can be used to describe a Java or a JavaScript language object. The advantage of using XML to describe a language object is it makes the object portable across operating systems, computer systems, and also allows objects to be sent across networks. JSON is another way of representing objects and represents object attributes as name, value pairs. Object converter provides methods that allow a language object to be converted to XML/JSON, and from JSON/XML back to the language objects.

As used herein, the phrase “Advertisement server” 170 refers to a server application on a server device that sends back data objects and program code based on a request. The program code can be script code and in an embodiment can be JavaScript. The data objects are objects with attributes and in a JavaScript embodiment can be JavaScript objects. In other embodiments they can be Java language objects [etc.] An Object converter is made use of to send data objects to a client. One of the parameters of a request is the type of objects, as an XML or JSON object. If a data object is sent as a JSON object, then there is no conversion required on the browser since it is a JavaScript object 230. The other parameters maybe query terms, affiliate id, client attributes, [etc.]. The query terms enable the server to select the data objects relevant to the query terms.

Another job of an Advertisement server 170 is to enable creation of the data objects 530 by customers 185. The customers access the advertisement server using a client device 180 and send parameters to create/modify/manage an advertisement 500. This enables the advertisement server to send back graphical user content enabling the customer to create data objects with attributes, creating an advertisement 510. An advertisement can be perceived as a data object, made up of attributes and methods 400. The data object gets converted into text and graphics on the client device by the program code into a viewable form. The advertisement data object might include attributes target area, fixed or bid type or click-sale, fixed price (read only attribute), bid price, target terms, [etc.] 410. The advertisement object further aggregates multiple data objects 420, 421, 422, . . . as a list 560. The data objects in the list have at least attributes title, description, show link, click link and a count threshold. The data object attributes may also include price, discount percentage, product code, compare link, compare identifier, image link, [etc.] 423. The data objects in the list might be created as a sequence of objects in an embodiment. The sequence allows the objects to be linked creating a cyclical structure. The advertisement object methods traverse the list to return the current object, update attributes, keep track of current object, count of objects, [etc.].

The customer creates an advertisement object by choosing a target area on the client device, chooses a price type,—if the price is fixed type, the price to show the data object on the target area is made available by the server device 540. If it is of bid type, the customer chooses a bid price to pay—creates the data objects with attributes title, description, show link, click link, [etc.] in sequence, chooses the count threshold for each data object and sets target terms if advertisement is to be targeted towards a set of query terms 540. In an embodiment, the bid price set by the customer may need to be higher than the minimum bid criteria set for a target area. The customer may also choose that the advertisement server automatically choose a target area to display the advertisement.

In other embodiments, a customer might also create an advertisement object with attributes, product name, description, sale price, discount percentage, product code, show link, compare link, target terms, price type, [etc.]. The advertisement server converts these attributes into a form as above into a data object with attributes title, description, show link, clink link, compare link, compare id, [etc.]. The customer instead of creating the advertisement through a graphical user interface might send across the advertisement objects as a data feed or using an Application Programmable Interface (api).

The graphical user interface also enables the customer to group advertisement objects into an advertisement campaign 520. The advertisement campaign is again a data object with attributes such as a name, budget, a daily spending limit, start date, end date or no end date. The budget attribute limits the advertisement expenditure to a set budget and stops the group of advertisements from being shown once the budget threshold is crossed. The daily spending limit is again a similar threshold limiting expenditure per day. The start date and end date attributes enables the group of advertisements to be shown for the period. A “no end date” shows the group, until budget thresholds are crossed.

A plurality of campaign objects can be created to create groups of advertisement objects. The plurality of campaign objects are grouped under a customer object with attributes such as name, company, address, email, user id, password, [etc.]. A daily limit attribute in the customer object allows spending expenditure to be limited across campaigns. Payment attributes, such as a credit number, card name, card type, enable customer to be billed for an advertisement.

The graphical user interface also allows the customer to view performance of the campaigns and billing statements. A performance summary shows the daily, monthly, yearly performance of the campaigns by impressions, clicks and charge. The daily and monthly performance summary allows further viewing the details by day, [etc.]. The campaign performance activity shows performance by campaign, money spent, daily impressions, clicks, charge, [etc.]. Links allow viewing details by each advertisement and client attributes such as client device address, session id, [etc.]. Billing statements made to the customer can also be viewed.

Yet another job of an advertisement server is to enable a publisher 195 to select target areas on a client display or choose the format of advertising to be shown on the client display. The publisher also connects to the advertisement server through a client display 190. A single or a plurality of advertisements may be shown in a target area. The publisher can choose the number of advertisements, the layout of the advertisement, horizontal layout or vertical layout or line layout, [etc.], the size of the layout, width, height, color of the layout, [etc.] 600. These can be done programmatically or using the graphical user interface. The publisher injects the generated program code, HTML tags into the HTML content on the publisher website allowing the advertisement to be served on a client request 610.

As used herein, the phrase “publisher” refers to the owner of a website on a server device. The publisher 195 owns or has access to the HTML content that is served through the web server 620. The publisher to monetize the website content serves advertisements along with content to be shown on the client device. The publisher embeds these advertisements in the form of text, graphics using HTML tags like <script>, <div> [etc.]. The advertisements could be just simple HTML text or images or program code and data objects. The program code and data objects could be retrieved from an advertisement server executing on the same server device or on another server device. The publisher refers to an advertisement server device using the src attribute of the <script> tag, and chooses a target area where the advertisement should be shown on the display device by specifying the id attribute of the <div> tag. The publisher can generate the tags programmatically or through a graphical user interface 190 of the advertisement server that allows the publisher to generate these. The publisher takes the content generated by the advertisement server and adds it to the HTML content. In an embodiment, the publisher can use programmable apis to embed advertisement into the HTML content.

System

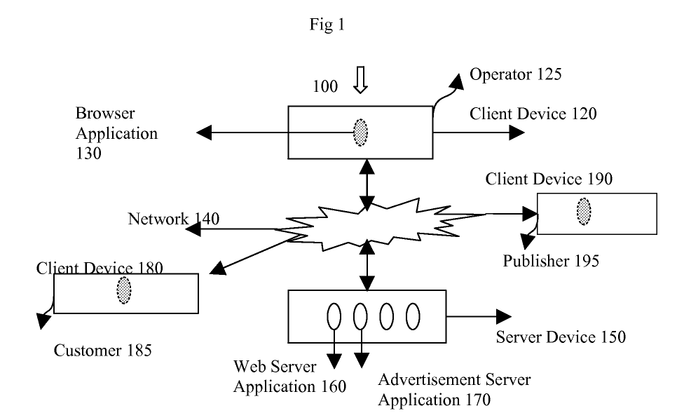

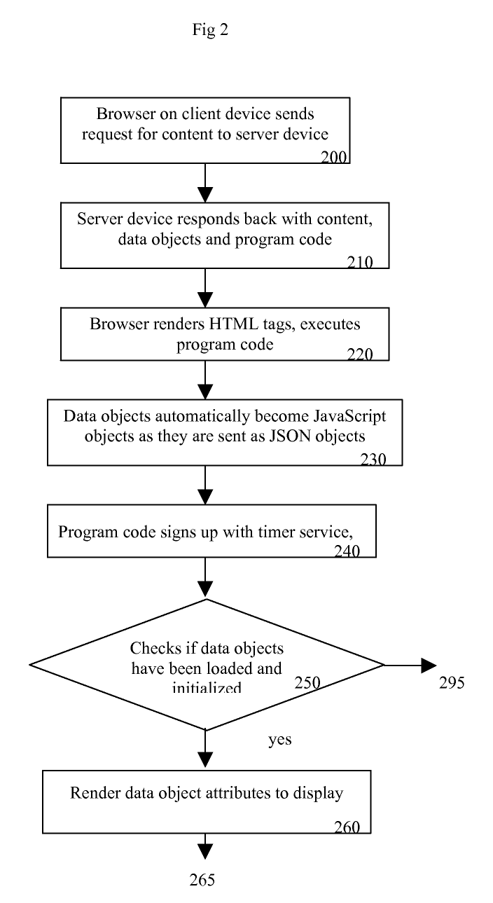

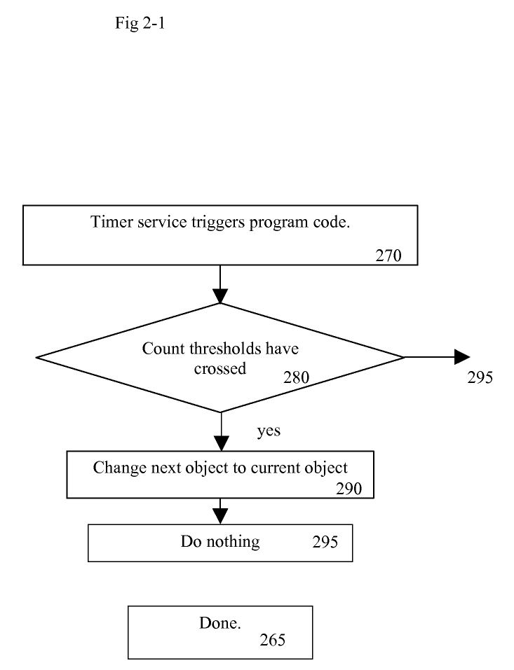

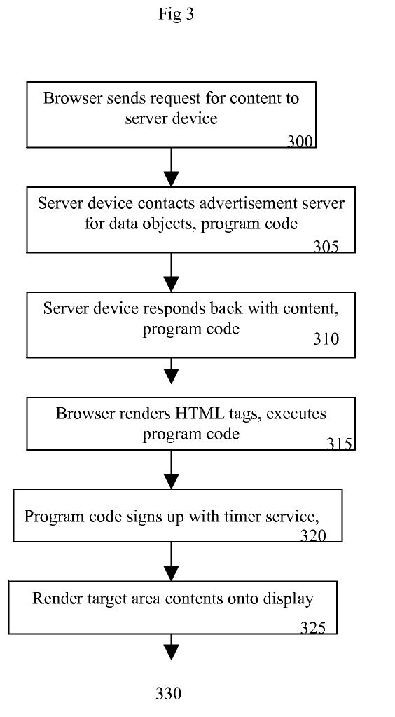

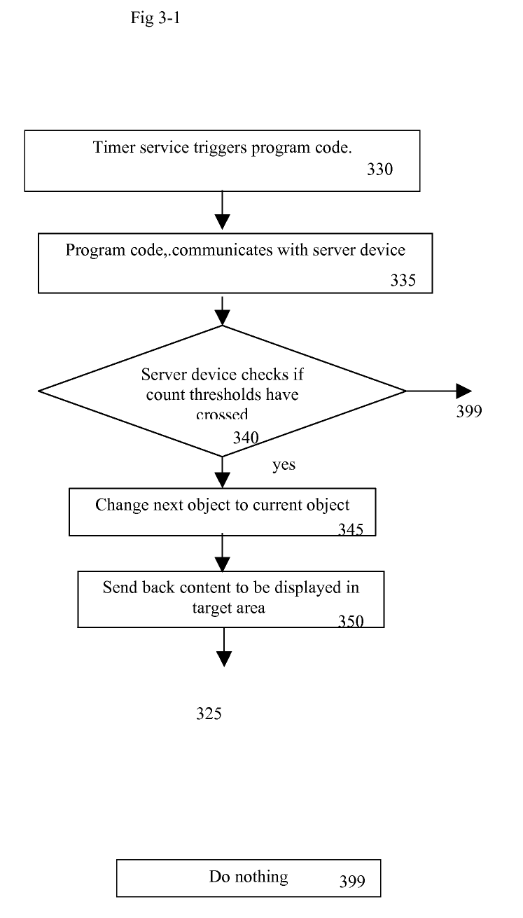

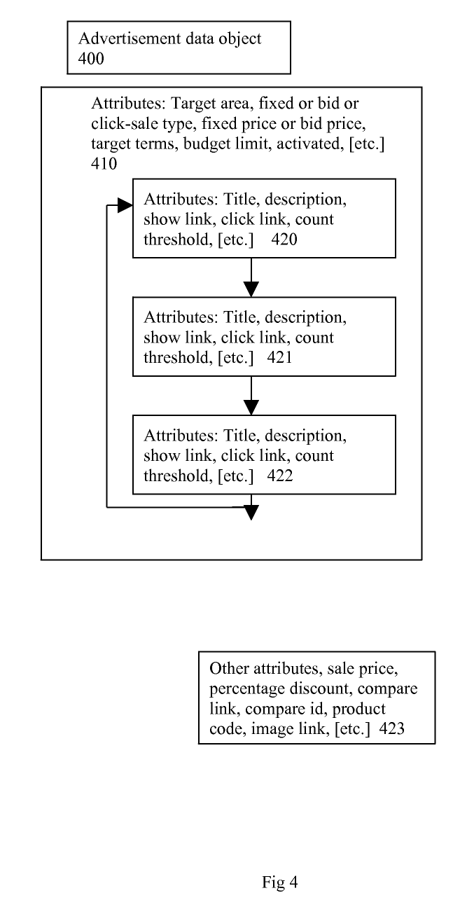

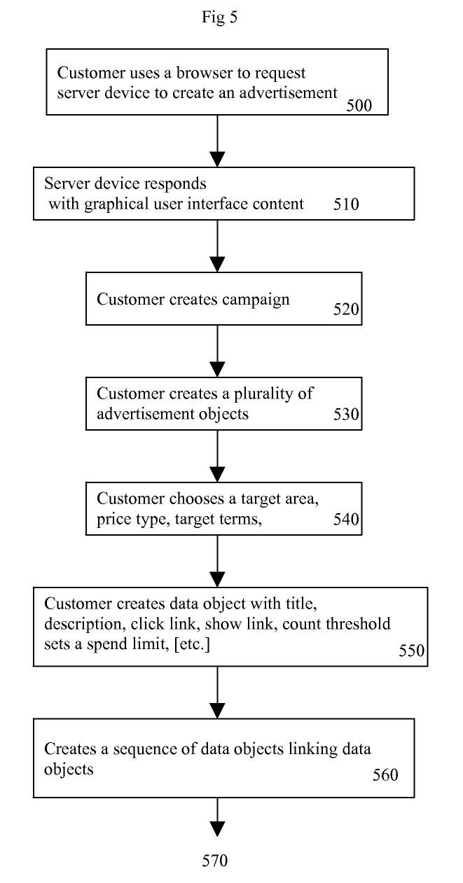

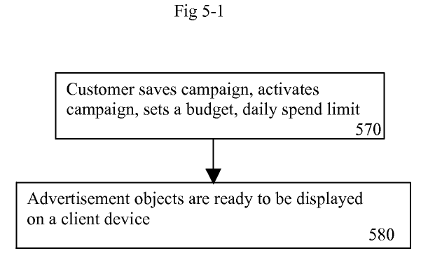

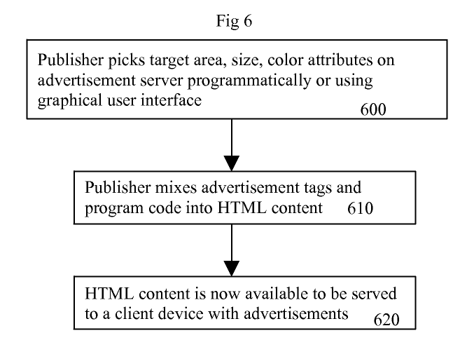

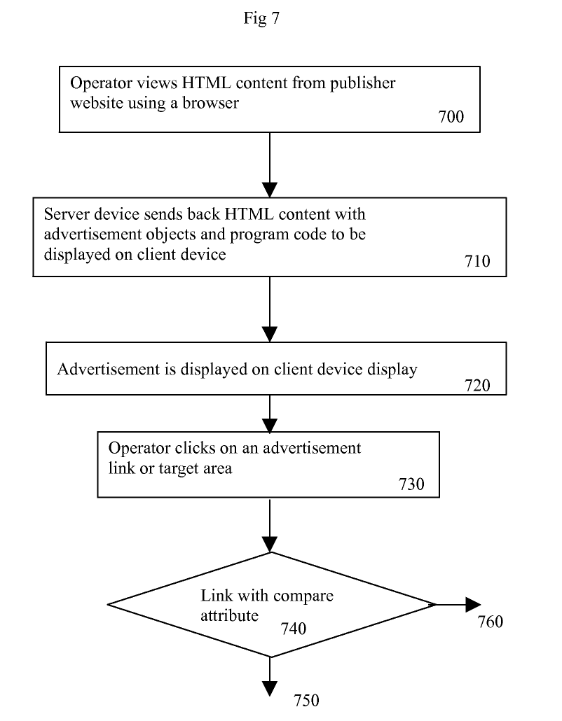

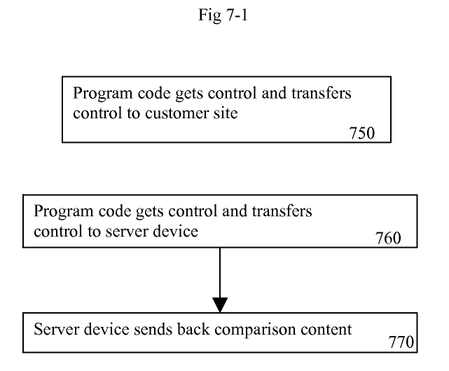

Referring first to FIG. 1, an advertising system 100 according to embodiments of the present invention is shown. As shown in FIG. 1, the advertising system 100 includes a client device 120, a server device 150, an operator or user or viewer of the client device 700. The operator uses the client device 120 and browser application 130 to access a server device by typing the address of the server device into the browser input. The browser communicates request 200 to the server device across the network 140. The server device sends back content to be rendered on the browser. In an embodiment, HTML content is returned by the server device 710. The HTML content includes advertisements to be shown on the display device 220, 720. The advertisements are made up of HTML tags, program code and data objects 210. The program code is loaded through the JavaScript <script> tag with the src attribute pointing to the JavaScript file to be loaded from the server device. The data objects 230 are again loaded using a JavaScript <script> tag with the src attribute pointing to the server device and taking as parameters a target area identifier, query terms, affiliate id, [etc.] The program code checks if the data objects have been loaded 250 and if so, renders the first data object on to the target area on the display using the size, width, color attributes, [etc.] 260. The data objects of an advertisement are linked such that there is a cyclical structure, the first object pointing to the second, second to the third, and the last to the first in an embodiment. In other embodiments, the data objects can be a list, with a count of number of objects in the list. An index can then be used to access the list. The program code also signs up with the timer service to be triggered at clock intervals 240. On a trigger, the program code checks the count threshold if it needs to refresh the display, and if so, gets a reference to the next object and makes that as the current object while rendering the attributes onto the display. The cyclical structure of the data objects and the continuous updates at trigger thresholds creates a visual perception of motion to the user or viewer of the display.

In an embodiment, advertisements are added to HTML content being sent from a server device using a server side program code such as Java. In such a embodiment, the server device which has received a request from a client device 300 with query terms, client attributes, [etc.] as parameters uses a established connection to an advertisement server including the said parameters, a target id, [etc.] and requests advertisements 305. The response from the server which is in the form of XML or JSON is converted to server side program code data objects using a data converter. The converted data objects are linked such that there is a cyclical structure, the first object pointing to the second, second to the third, and the last to the first in an embodiment. In other embodiments, the data objects can be a list, with a count of number of objects in the list. An index can then be used to access the list. The server side program code in the language manipulates the different attributes using the object methods to convert attributes into plain HTML tags and mixes it with the HTML content being sent across to the client device. The mix includes program code to be executed on the client device 310. The program code gets executed 325 on load by the browser 315 in an embodiment enabling the program code to sign up to be triggered on a clock signal 320. On a trigger 330, the said program code makes a XMLHttpRequest to the said server device 335. The server side programming code that is keeping track of the data objects being shown in a target area changes the current object to the next object 345 if count thresholds are crossed 340. The object methods are manipulated again to convert the object attributes to HTML which is sent back to the client device 345, and the program code on the client device renders 325 the HTML sent back onto the display device 350. The cyclical structure of the data objects and the continuous updates at the trigger thresholds creates a visual perception of motion to the user or viewer of the display.

In an embodiment, advertisements are sent as data objects along with program code back to the client device. The program code on execution establishes a Server push type connection to the server device. It also signs up with the timer service to be triggered at clock signals. The clock signal trigger as before enables program code to render the data objects onto the display. But after a pre-configured number of iterations, the client code makes a request back the server device for new set of data objects and the server device responds by sending a new set of data of objects and maybe program code. In other embodiments instead of the program code making a request for new objects, the server device which is keeping track of time on the server side sends back more data objects and maybe program code to the client device allowing the program code to change the data objects being refreshed onto the display with the new data objects received. This type of functionality allows a viewer of the client device to continuously see new data objects on the client device display.

In an embodiment, an operator of the client display viewing the advertisement may click on a link in an advertisement or click on a target area enabling program code to be executed 730. The executed code enables the browser to request content from the server device in the click link attribute. In an embodiment, the request could transfer control to the content from the server device 750. In other embodiments, the request could be initiated using a new browser window allowing the advertisements and content being shown on the display to still be visible. In an embodiment, a click on a compare link enables the program code to enable the browser to request content from the server device 760 in the compare link passing as parameters a compare id. The server device on receiving the request from the client device with a compare id, responds back with compare content 770 to be displayed on the client display.

Advertisement Database

The advertisement data objects created by the customer using the client device are stored on a server side storage device. Each advertisement object is stored in a storage file or as a record on the storage device using a data source. The name of the storage file or key can include advertisement attributes campaign identifier and customer identifier allowing the advertisement objects to be grouped by campaign and customer. In an embodiment an advertisement can be stored as an object itself using an Object converter. The campaign objects are again stored as a storage file or as a record or as an object file. The name of the storage file or key can include the attribute customer identifier allowing the campaign objects to be grouped by a customer. The customer object is again stored as a storage file or as a record or object file. The name of the storage file can include the customer identifier.

When the advertisement server is started, it reads the customer objects, and reads all the campaign objects and further reads all the advertisement objects in a campaign. It organizes the objects by target area, if specified and uses a tree type structure to sort the objects by fixed price and bid price objects. When a request from a client device is received, the target identifier allows the server to identify the tree structure to use. The fixed price type objects have priority over the bid price type and are sent back first. A request parameter includes the number of advertisement objects to be sent back. The id attribute is assigned a unique time stamp so that an advertisement can be tracked before it is sent. An accounting record is created on the server side of sending the advertisement object. The record includes id, advertisement object attributes, and client parameters, [etc.]. The server also keeps track of the objects sent back so as to not send the same objects again. If a fixed price type object daily limits or budget thresholds are crossed then the object is removed from the tree. If there are no more fixed price type objects to be shown, then the highest bid objects for the target area are shown first. If there are no bid objects, then objects with no specific target area are selected to be sent back. If the request parameters include query terms such as city, product name, search terms, [etc.], the server initiates a query match on an index and returns matching advertising objects containing the terms. In an embodiment this can be the name of the storage file containing the advertising object or a key containing the terms customer id, campaign id and advertisement object id. The server uses the key to search the tree for the advertisement object and adds it to the list of objects to be returned.

Each impression shown is accounted for on the server device and also on the client device. The display of an advertisement on the client device is kept track of by analyzing the log files to confirm that an advertisement was indeed shown by matching the server side timestamp id and timestamp id sent back by the program code on an advertisement display on the client device. Similarly a click on a target device or a link is accounted for from the log files by matching the ids.

A script is executed on the advertisement server daily that goes through the accounting records and log files to match and account for an advertisement shown, clicked, [etc.]. The performance information by advertisement object, campaign, and customer are generated by the script. A graphical user interface allows the customer to access and view advertisement performance including billing information from a client device. Billing a customer could be through a credit card, ACH, [etc.]

Although the present invention has been described with respect to a preferred embodiment thereof, those skilled in the art will note that various substitutions may be made to those embodiments described herein without departing from the spirit and scope of the present invention. Object attributes, program code, and functions specified and described herein have been selected for clarity of exposition, and do not represent all possible transformations or combinations. Those skilled in the art will also note that although embodiments of the present invention have been described in the context of target areas, timing mechanism, object attributes, program code, display, client device, server device, [etc.] certain features or embodiments may also apply to other forms of advertising not shown or discussed.

What is claimed is:

1. A method for displaying advertisements in a computer based system comprising:
(a) a client device with a clock signal means, a display means and program code execution means; said clock signal means generates a signal periodically; said client device provides a means for said program code to sign up; said sign up triggers said program code to be executed at said signal; said display shows content; said content can be text or graphics [etc.],
(b) a server device that waits for client devices to communicate; said server device sends back a plurality of data objects and program code as response; said program code is executed on said client device; said data object has a plurality of attributes; said attributes make up an advertisement,
whereby said program code execution renders said data objects on said client display; said execution also enables program code to sign up with said client device to be triggered at said clock signal; said clock signal trigger enables said program code to be executed and change said data objects on the said display; said execution also enables program code to communicate with said server device.

2. The method of claim 1 further comprising, selecting a plurality of target areas on said display by said program code; said target area enables program code to change content on said display without affecting content in other areas on said display.

3. The method of claim 1 further comprising said server device to initiate communication with said program code being executed on said client device; said communication enables server device to send said data objects and program code to said client device.

4. The method of claim 1, wherein said server device sends back data objects with a plurality of attributes; one said attribute allows said program code to count said clock signals; said count attribute enables program code to change data object when count thresholds are crossed.

5. The method of claim 2, further comprising trapping clicks on said client device in said target areas or on a link in said target area; said link is an attribute of said data object; said click means maybe an input or pointer device; said click triggers said program code to be executed; said execution enables said client device to communicate and receive content from a server device.

6. The method of claim 2 wherein said program code changes said data objects in said target areas at said clock signal and said count thresholds,
whereby said cyclic change on said display creates a visual perception of motion.

7. The method of claim 5, further comprising tracking said clicks, counts and client attributes; said clicks, counts and client attributes are communicated back to said server device by said program code; said server device persists these said clicks, counts and client attributes.

8. The method of claim 7 wherein, said clicks, counts and client attributes are used to bill customers for the advertisements shown on said client device.

9. The method of claim 8, wherein said customers create said data objects sent by the said server device; said customers use a client device communicating across a network to access said server device; said communication enables said server device to send across content enabling customers to create said data objects with a plurality of attributes.

10. The method of claim 9, wherein said data objects created have at least attributes title, description, a shown link, a click link, a trigger count, target area, target terms, a bid price or fixed price or click-to-sale type, a reference to another data object; said content sent back by said server device enables customer to connect data objects together; said connections enable said program code to change data objects at said clock and count triggers.

11. The method of claim 10, wherein said attribute fixed price can be configured on said server device; said fixed price can be increased or decreased based on demand and target area where data objects are to be displayed; said fixed price has priority over a said bid price; said priority determines showing data object with fixed price type even when there is a competing data object with a higher price of bid price type.

12. The method of claim 11, wherein said attribute bid price is set by a forward auction; said bid price increases or decreases through customer bidding.

13. The method of claim 1, further comprising said client device to send query terms to said server device.

14. The method of claim 13, wherein said server device uses said query term to match attributes target terms, title, description, [etc.] in said data objects and send back matching data objects relevant to query terms.

15. The method of claim 1 0 wherein, said data object with a plurality of attributes may also include attributes a sale price, a discount percentage, a compare link, a compare identifier, image link, [etc.].

16. The method of claim 5 wherein, a click is trapped in a target area; said click maybe on a link displayed in said target area; said link type maybe a compare link; said link type enables said client device to communicate with a server device with at least said compare identifier as a parameter; said compare identifier enables said server device to send back comparison content to the client device; said comparison content may further include a plurality of customer links.

17. The method of claim 8, wherein a customer is billed; said billing is per impression or per click or click-to-sale; said billing type is fixed or bid or click-to-sale; said impression is content shown on said client device display once or many times; said per click is a click in said target area; said click-to-sale is a sale resulting from a said click.

18. The method of claim 1 wherein, said advertisement is text or graphics and may include sound.

19. The method of claim 10, wherein said attribute link is a communication identifier comprising of an address; said address may include numbers and text.

20. The method of claim 2, wherein said target area is an area on said display; said area allows said content to be displayed without affecting other content on said display.

21. The method of claim 1, wherein said client device maybe a general purpose computer; said client device executes a client application that can connect to a server device across a network; said client application can render content and execute program code sent back by server device.

22. The method of claim 1, wherein said server device maybe a general purpose computer; said server device executes a server application that accept requests from a plurality of client devices across a network and sends back a response.
